(19) United States
(12) Patent Application Publication
(10) Pub. No.: US 2015/0093932 A1
(43) Pub. Date: Apr. 2, 2015

(54) FIXING DEVICE AND CONNECTOR ASSEMBLY HAVING THE SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: WAN-LI NING, Shenzhen (CN); HAN-BING ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/060,612

(22) Filed: Oct. 23, 2013

(30) Foreign Application Priority Data
Sep. 30, 2013 (CN) 2013104556854

(51) Int. Cl. H01R 13/627

(52) U.S. Cl. CPC H01R 13/6275
USPC 439/369

(57) ABSTRACT

A connector assembly includes a first connector, a second connector, a first holding member, and a second holding member pivotably connected to the first holding member. The first connector includes a first connecting portion, and a first cable and a blocking portion connected to opposite ends of the first connecting portion. The second connector includes a second connecting portion and a second cable connected to an end of the second connecting portion. A latching portion protrudes from the second cable adjacent to the second connecting portion. The first holding member is fitted about the first connecting portion and is blocked by the blocking portion. The second holding member is latched with the latching portion.

### CROSS-REFERENCE OF RELATED APPLICATIONS

Relevant subject matter is disclosed in a pending U.S. patent application, titled “FIXING DEVICE FOR TWO CONNECTED CONNECTORS”, filed on Oct. 18, 2013, with the application Ser. No. 14/056,973, which is assigned to the same assignee as this patent application.

### BACKGROUND

1. Technical Field

The present disclosure relates to a connector assembly including a fixing device.

2. Description of Related Art

Extension cords are often connected to power lines to lengthen the power lines when the power lines are not long enough. However, connectors of the extension cord and the power line are often fixed to each other only with friction. As a result, the connectors are easily disengaged from each other when the connectors are impacted or the lines are pulled by accident.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a connector assembly.

FIG. 2 is an assembled, isometric view of FIG. 1.

FIG. 3 is similar to FIG. 2, but shows a using state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

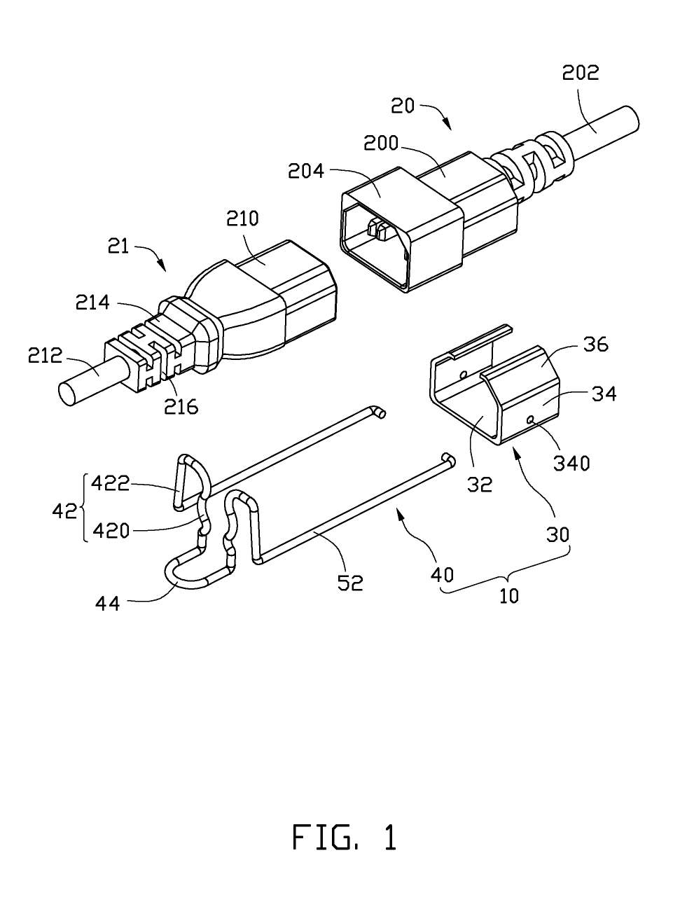

FIG. 1 shows an embodiment of a connector assembly. The connector assembly includes a fixing device 10, a first connector 20, and a second connector 21.

The fixing device 10 includes a first holding member 30 and a second holding member 40.

The first connector 20 includes a first connecting portion 200, and a first cable 202 and a blocking portion 204 connected to opposite ends of the first connecting portion 200.

The second connector 21 includes a second connecting portion 210 and a second cable 212 connected to an end of the second connecting portion 210. A latching portion 214 extends from the end of the second connecting portion 210, and encloses a part of the second cable 212 adjacent to the second connecting portion 210. An annular engaging slot 216 is defined in an outer surface of the latching portion 214.

The first holding member 30 includes a connecting piece 32, two arms 34 substantially perpendicularly extending up from opposite ends of the connecting piece 32, and two blocking pieces 36 slantingly extending up and toward each other from top sides of the arms 34. The arms 34 each define a through hole 340.

The second holding member 40 includes two U-shaped sandwiching portions 42, a U-shaped operation portion 44, and two connecting bars 52. Each sandwiching portion 42 includes a clamping portion 420 adjacent to the other sandwiching portion 42, and a resilient portion 422 away from the other sandwiching portion 42. The operation portion 44 is perpendicularly connected between the clamping portions 420, with opposite ends of the operation portion 44 connected to distal ends of the clamping arms 420.

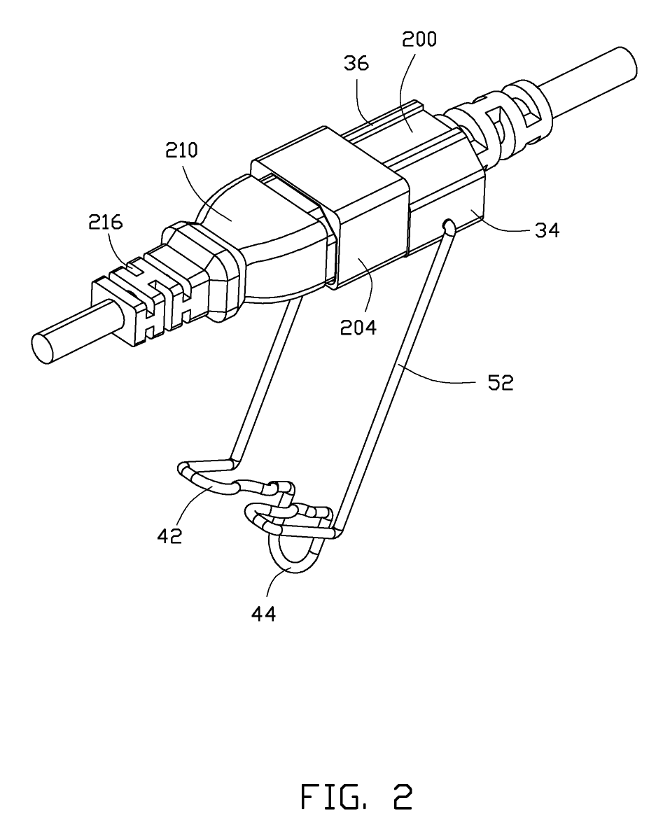

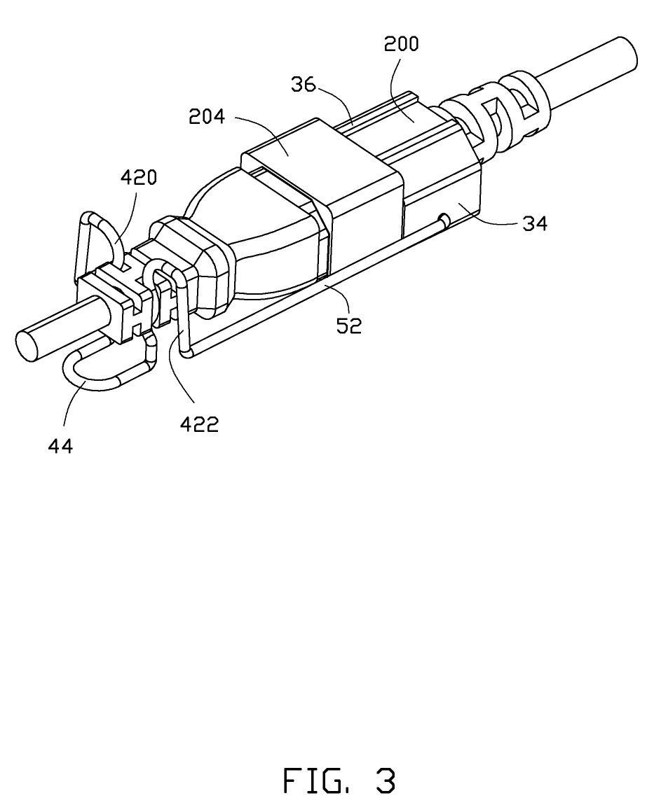

FIGS. 2 and 3 shows that the connecting bars 52 extend from distal ends of the resilient portions 422 and extend away from the operation portion 44 to be pivotably inserted into the through holes 340.

In assembly, the first connector 20 is connected to the second connector 21. The first holding member 30 is fitted about the first cable 202 and then is slid toward the second connector 21, until the first holding member 30 abuts the blocking portion 204. At this time, the connecting piece 32 and the blocking piece 36 respectively abut the bottom and top sides of the first connecting portion 200, the arms 34 abut the opposite sides of the first connecting portion 200.

The connecting bars 52 are then pivoted toward the second connector 21, to allow the clamping portions 420 to engage in the engaging slot 216, thereby fixing the second connector 21 to the first connector 20.

In disengaging the first connector 20 from the second connector 21, the operation portion 44 is pivoted away from the second connector 21, to disengage the clamping portions 420 from the engaging slot 216. The first connector 20 and the second connector 21 are then readily pulled away from each other.

In another embodiment, one of the connecting bars 52 can be omitted.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fixing device for fixing a first connector and a second connector connected to each other, the fixing device comprising:
a first holding member to be mounted to the first connector, the first holding member comprising a connecting piece and two arms extending up from opposite ends of the connecting piece; and
a second holding member to be mounted to the second connector, the second holding member comprising two sandwiching portions to engage with the second connector, and a connecting bar extending out from one of the sandwiching portions and pivotably connected to one of the arms.

2. The fixing device of claim 1, wherein the first holding portion further comprises two blocking pieces extending toward each other from distal ends of the arms.

3. The fixing device of claim 1, wherein the second holding portion further comprise an operation portion, each sandwiching portion is U-shaped and includes a clamping portion and a resilient portion, the operation portion is connected between distal ends of the clamping portions.

4. The fixing device of claim 3, wherein the connecting bar extends from a distal end of one of the resilient portions.

5. A connector assembly comprising:
a first connector comprising a first connecting portion, and a first cable and a blocking portion connected to opposite ends of the first connecting portion;
a second connector comprising a second connecting portion and a second cable connected to an end of the second connecting portion; a latching portion protruding from the end of the second connecting portion and enclosing a part of the second cable adjacent to the second connecting portion;
a first holding member fitted about the first connecting portion and blocked by the blocking portion; and
a second holding member pivotably connected to the first holding member and detachably engaging with the latching portion.

6. The connector assembly of claim 5, wherein the first holding member comprises a connecting piece and two arms extending up from opposite sides of the connecting piece to abut opposite sides of the first connecting portion.

7. The connector assembly of claim 6, wherein the first holding portion further comprises two blocking pieces slantingly extending up and toward each other from top sides of the arms.

8. The connector assembly of claim 6, wherein the second holding member comprises two sandwiching portions and a connecting bar extending out from one of the sandwiching portions and pivotably connected to one of the arms, the sandwiching portions sandwich the latching portion.

9. The connector assembly of claim 8, wherein the second holding portion further comprise an operation portion, each sandwiching portion is U-shaped and includes a clamping portion and a resilient portion, the operation portion is connected between distal ends of the clamping portions.

10. The connector assembly of claim 9, wherein the connecting bar extends from a distal end of one of the resilient portions.

11. The connector assembly of claim 9, wherein the latching portion defines an engaging slot, the clamping portions are detachably engaged in the engaging slot.
